(19) United States
(12) Patent Application Publication
(10) Pub. No.: US 2023/0239742 A1
(43) Pub. Date: Jul. 27, 2023

(54) Computer Implemented Method For Allocating Wireless Network and Adaptive Video Streaming Resources

(71) Applicant: Fundacio Privada I2CAT, Internet i Innovacio Digital a Catalunya, Barcelona (ES)

(72) Inventors: Miguel Catalan Cid, Barcelona (ES); August Betzler Plans, Barcelona (ES); Daniel Camps Mur, Barcelona (ES)

(73) Assignee: Fundacio Privada I2CAT, Internet i Innovacio Digital a Catalunya, Barcelona (ES)

(21) Appl. No.: 18/000,820

(22) PCT Filed: Jun. 7, 2021
(86) PCT No.: PCT/EP2021/065141

§ 371 Date: Dec. 5, 2022

(30) Foreign Application Priority Data
Jun. 8, 2020 (EP) 20382491.7

(51) Int. Cl. H04W 28/20; H04L 65/1101; H04L 65/61

(52) U.S. Cl. CPC H04W 28/20; H04L 65/1101; H04L 65/61

(57) ABSTRACT

A computer implemented method allocates wireless network and adaptive video streaming resources in environments with high device density. The network has one or more access points and at least one user device. The stages of the method include obtaining the information from radio access network or video service telemetry; generating a resource allocation list between each user device and at least one channel with an associated representation index, distributing the resource allocation list, performing at least one handover and at least one video rate recommendation.

### TECHNICAL FIELD OF THE INVENTION

The present invention relates to allocating network resources, and more particularly to a computer-implemented method for allocating wireless network and adaptive video streaming resources.

### BACKGROUND OF THE INVENTION

It is well known that in the field of telecommunications, the use of mobile devices is constantly growing. At the same time, the growing use of mobile devices is associated with a growth in the use of applications that are increasingly consuming more bandwidth. For all this, there are more and more scenarios in which there is a high density of user devices demanding a large bandwidth which leads to a saturation of the network. These data are studied in the report VNI Cisco. 2018. Cisco visual networking index: Forecast and trends, 2017-2022. (2018) in which current trends are analyzed and reflected as more than half of global bandwidth corresponds to video streaming services and this trend is expected to increase in coming years.

A clear example of this can be the scenario of an intercontinental flight, where the protocols for wireless networks are not sufficient to avoid network congestion and wired environments are necessary to allow connectivity for all user devices. The disadvantage of this solution is related to the maintenance of the physical infrastructure, which can easily deteriorate through continued use, leading to a high cost in maintenance or even repair of the network. For this reason, wireless solutions are sought for this problem.

Currently, the technology mainly used in these cases is Dynamic Adaptive Stream over HTTP (DASH). The problem with this solution is that the entire burden of resource optimization falls on the user device, who does not have a global vision of the network infrastructure that allows him to make better decisions. Therefore, the Server and Network Assisted DASH (SAND) extension was proposed to provide global network information to user devices through the exchange of messages with additional servers or proxies known as DASH Assisting Network Elements (DANE). However, in dense wireless scenarios additional solutions to optimize the allocation of wireless resources are also needed. This may also occur when using other adaptive non-DASH based video streaming solutions where video rate selections are taken by the user device.

For all this, it is necessary a method that joins a proper allocation of wireless network and adaptive video streaming resources in environments of high density of devices to contribute to a greater satisfaction in the Quality of Experience.

### SUMMARY OF THE INVENTION

The invention proposes a method for allocating wireless network resources and adaptive video streaming resources that overcome all the above-mentioned drawbacks and limitations.

The method allows allocating wireless network resources and video rates, comprising the method the following steps:
obtaining data at least from the radio access network or video service telemetry;
generating a resource allocation list between each user device and at least one channel with an associated representation index or video rate;
distributing the resource allocation list.

More specifically, adaptive video streaming resources may include DASH video streaming resources or video rates, among others.

The steps of the method are performed in a device for allocating network resources (as for example: a computer). In this regard, it is generated a list of recommended video rate and channel assignment for at least one user device.

More specifically, the main objective of this method is to allocate wireless network and adaptive video streaming resources in such a way as to guarantee a fair distribution of available resources in order to contribute to greater satisfaction of the Quality of Experience.

In a preferential implementation, the network consists of at least one user device and one access point that must be managed in order to allow resource distribution. Each user device, in turn, has at least one representation index that determines the quality or video rate of the video he or she wants to view.

Please note that this method tries to solve an NP-hard problem so the generated allocation can be a heuristic solution close to the optimal solution but with a much lower computational cost, which is a great advantage.

In a preferential implementation, in order to achieve a fair distribution of network resources, the method uses the criterion of max-min airtime fairness to provide proportional fairness between user devices. To this end, the method consists of a progressive algorithm that gradually increases the video rate or the representation index associated with each user device according to the airtime consumption of the user devices.

According to another aspect of the invention, the method can implement an additional stage which consists of implementing the resource allocation list. Preferably, the implementation of the resource allocation list is done by managing the necessary handovers for the proper assignment of each user device to a channel according to the resource allocation list, and by recommending a video rate for the proper assignment of each user device to a representation index according to the resource allocation list.

In order to manage the handovers, the method requires network triggered handovers, which is a feature not available in standard Wi-Fi enterprise systems. For this purpose, the method adopts a network model based on the BIGAP architecture, where all access points share the same Basic Service Set Identifier and their radio interfaces are assigned to a number of orthogonal channels according to the number of access points. Thus, association control relies on Dynamic Frequency Selection signaling to provide seamless channel switching (i.e. handovers). However, the method could also be implemented in other Software Defined Wireless Network architectures as, for instance, solutions based on creating one single virtual access point per station.

According to another aspect of the invention, the distribution of the resource allocation list involves communicating to each user device the recommended video rate generated by this method, which is a procedure not available in standard adaptive video streaming services. Preferably, in DASH-based services, the communication will be done through the DANE server connected to each user device. Accordingly, the DANE server sends a message to each user device with the video rate recommended to this user device. However, the method could also be implemented in a different way.

According to another preferred embodiment, each access point has at least one wireless interface assigned to one channel. In addition, the data obtained by the radio access network or video service telemetry method is comprised of the effective wireless bandwidth of a user device on a channel, and the available airtime on a channel. Preferably, the effective bandwidth is calculated as the nominal PHY data rate achievable given the channel conditions of a user device multiplied by the efficiency of the channel. To calculate the channel efficiency, the different channel access and protocol overheads are taken into account. To collect all the effective wireless bandwidth, preferably, each access point is equipped with an additional monitoring interface that captures the Received Signal Strength Indicator of the stations operating in other active channels of their radio access network, although other methods could be implemented. In addition, each access point keeps track of the available airtime in a channel which includes interference and congestion. A network administrator can modify the available airtime in a channel of each access point to take into account the existence of background traffic or reserved wireless resources.

Similarly, the method may also involve obtaining data from the video stream demanded by at least one client. Preferably, the data refers to the number of available representation indexes and video rates of the video stream, which can be obtained by two different procedures. The first procedure comprises obtaining the data by inspecting the MPD files. By the other hand, the second procedure comprises implementing SAND messages to the user devices, and preferably to the DASH client from the user device. All this data is acquired periodically by the method.

According to another aspect of the invention, generating the resource allocation list between each user device and at least one channel with an associated representation index requires checking if the next representation index associated to the user device means that the airtime capacity of the channel is still not exceeded, being understood by next representation index associated to the user device that which corresponds to the next higher representation index associated to the user device. One of the ways to perform this check when the actual channel assigned to the user device corresponds to the channel being checked is adding the airtime consumption of the representation index associated to the user device and, in turn, subtracting the airtime consumption of the next representation index associated to the user device to the available capacity of the channel and checking if the available capacity of the channel resulting from the operation is still greater than or equal to 0. In case the channel assigned to the user device is different from the channel being checked, one of the ways to perform this check is by adding the airtime consumption of the next representation index associated to the user device and checking if the available capacity of the channel resulting from the operation is still greater than or equal to 0.

In a preferential realization, if the next representation index associated to the user device does not exceed the capacity of the channel, the available capacity of any channel that has been involved in the check is updated and/or the representation index associated to the user device is updated. Also, the airtime consumed by the user device in all the available channels is updated. In addition, if the channel assigned to the user device is different from the channel being checked, the channel being checked is assigned as the user device associated channel.

In a preferential realization, the check is only carried out in those cases where there is a next representation index associated to the user device.

In a preferential realization, the user device is obtained from a list. Preferably, this list is made up of tuples, with one tuple for each possible combination between user devices and available channels in the network. Preferably, the tuple comprises at least two elements, one of which is the airtime consumed by the user device in the associated channel using a representation index and another element is the user device video rate using the representation index. In this sense, in a preferential realization, at least these two values are initialized using the lowest representation index associated to the user device.

In a preferred embodiment, the items on the list are sorted in ascending order using the airtime consumed by a user device associated with a channel using a representation index as a primary sorting key and the video rate associated with a representation index as a secondary sorting key.

In a preferential execution, check whether the next representation index associated with the user device means that the capacity of the channel is still not exceeded is done in a loop. The loop exit condition may be that the representation index associated to a user device of each user device is the maximum representation index available to the user device or that any increase in the representation index of any user device entails exceeding the available capacity of any channel.

The object of the present invention is also a data processing device comprising means for carrying out the steps of any embodiment of the method of the invention.

### DESCRIPTION OF THE DRAWINGS

The previous advantages and characteristics, in addition to others, shall be understood more fully in light of the following detailed description of exemplary embodiments, with reference to the drawing attached, which must be taken by way of illustration and not limitation, wherein:

FIG. 1: It shows an example of state diagram for some of the steps of the method.

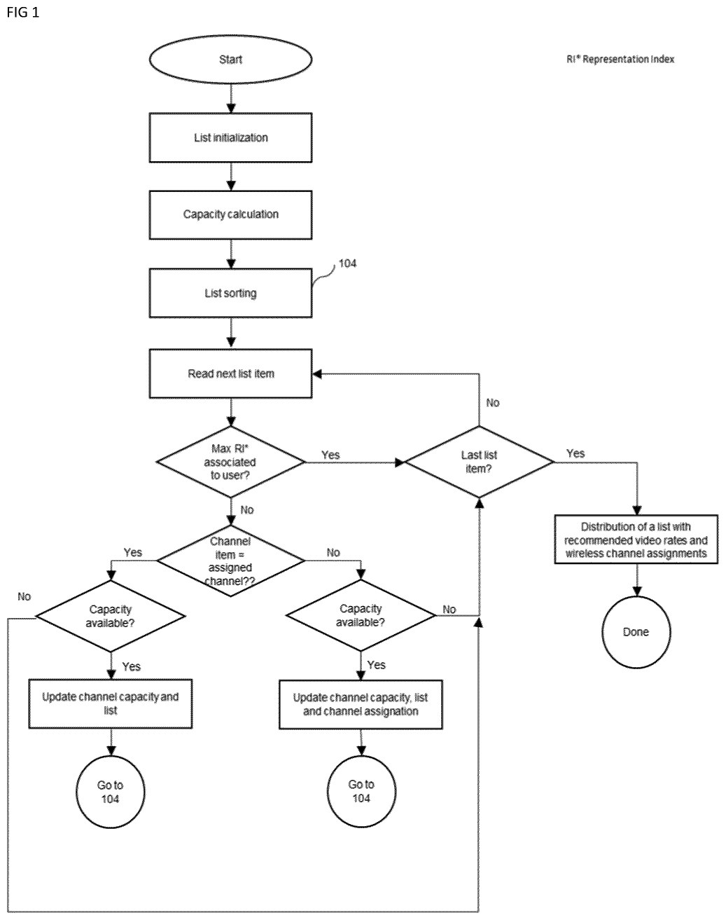

### DETAILED DESCRIPTION OF THE INVENTION

As mentioned above, the basic embodiment of the method according to the invention comprises the following steps:
obtaining data at least from radio access network or video service telemetry;
generating a resource allocation list between each user device and one channel with an associated representation index;
distributing the resource allocation list;
implementing the resource allocation list performing at least one handover;
implementing the resource allocation list performing at least one video rate recommendation;

In a preferential realization, this method is applied in a network that is formed by multiple access points, each of the access points having several channels, and several user devices receiving adaptive video streams, each of which has multiple available representation indexes or video rates.

In addition, the resource allocation list comprehends a channel assignment and a video rate recommendation per each user of the network.

To obtain the network information, the method obtains from each access point the effective wireless bandwidth and the available airtime of each of its channels. The effective wireless bandwidth is the nominal PHY data rate achievable given the channel conditions of a client, multiplied by its efficiency, while channel efficiency considers the different channel access and protocol overheads. In a preferred embodiment, each access point has a monitoring interface that collects the received signal strength indicator of the access points operating in other channels.

In addition, the method obtains the multiple representation indexes and the representation rate associated to each one of the representation indexes. In a preferred embodiment, this is achieved by inspecting the MPD files of the clients or by using SAND extensions.

Once the information is obtained, a list of tuples is constructed whose first element is the airtime consumed by a user device in a channel using a representation index and the second element is the video rate associated with the representation index for the user device. On the other hand, the channel currently assigned to each user device is saved in a resource allocation list.

The items in the list are then initialized using each user device lowest representation index. Then, for each channel, its available airtime is calculated by consulting the resource allocation list to obtain the set of user devices that are associated with the channel and, by consulting the list of tuples, to obtain the airtime consumed by the user device in the channel and subtract them from the airtime of the channel.

The next step (block 104) comprises sorting the items on the list in ascending order using the airtime consumed by a user device associated with a channel using a representation index as a primary sorting key and the video rate associated with a representation index as a secondary sorting key.

Once the items on the list are initialized, the following steps are performed for each item on the list:
Check if the representation index associated to the user device of the first tuple is the maximum representation index associated to the user device. If they are identical, it goes on to the next element on the list. If they are different, it goes on to the next step.
Check if the channel assigned to the user device in the resource allocation list is the same as the channel of the list element. If so, calculate the available capacity of the channel plus the airtime consumed by the user device using its actual representation index minus the airtime consumed by the user device using the following increased representation index associated to the user device, and check whether it is greater than or equal to zero. In the case of the second affirmative check, the available capacity of the channel is updated with the calculated value, all tuples associated to the user device are updated with the airtime consumed by the user device in the different channels using the following increased representation index associated to the user device and the user device video rate associated to the following increased representation index associated to the user device. Then, go to block 104. In the case of the first negative check, the second check is not performed and the next step is taken. In the case of the second negative check, it is passed to the next element in the list.
Check if the channel assigned to the user device in the resource allocation list is different from the channel of the list element. If so, calculate the available capacity of the channel minus the airtime consumed by the user device using the following increased representation index associated to the user device and check whether it is greater than or equal to zero. In the case of the two affirmative checks, the available capacity of the channel is updated with the calculated value; the capacity of the channel associated to the user device in the resource allocation list is updated by adding to the capacity of the channel associated to the user device in the resource allocation list the airtime consumed by the user device using the representation index; all tuples associated to the user device are updated with the airtime consumed by the user device in the different channels using the following increased representation index associated to the user device and the user device video rate associated to the following increased representation index associated to the user device. The channel assigned to the user device in the resource allocation list is then updated with the channel of the list element. Then, go to block 104. In the case of the first negative check, the second check is not performed and it goes to the next element in the list. In case of being the second negative check, it goes to the next element of the list.

Once the entire list has been run, all user devices will have the maximum representation index associated with the user device or increasing the representation index associated with the user device implies exceeding the available capacity of any of the channels. This way, the list contains in the second element of the tuple the video rate associated to the representation index for the user device and the resource allocation list contains the channel to be assigned to each user device.

With this information, a recommended video rate is sent to each client and the necessary handovers are made to implement the resource allocation list.

1. A computer implemented method for allocating wireless network and adaptive video streaming resources, wherein the network has at least one user device, the user device receiving an adaptive video stream, and at least one access point, the access point operating at least in one channel, the method comprising the following steps:
a) obtaining data at least from radio access network or video service telemetry;
b) generating a resource allocation list between each user device and at least one channel with an associated representation index;
c) distributing the resource allocation list;
d) implementing the resource allocation list performing at least one handover;
e) implementing the resource allocation list performing at least one video rate recommendation.

2. A method according to claim 1, wherein the data obtained at least from radio access network or video service telemetry comprises the effective wireless bandwidth experienced by at least one user device in at least one channel and the available airtime in at least one channel.

3. A method according to claim 1, wherein each access point is equipped with at least one monitoring interface that captures the received signal strength indicator of the access points operating in other channels.

4. A method according to claim 1, wherein the step of obtaining data at least from radio access network or video service telemetry comprises achieving at least the number of available representation indexes or the video rates of the video stream at least of one user device.

5. A method according to claim 4, wherein achieving at least the number of available representation indexes or the video rates of the video stream at least of one user device involves inspecting the MPD files or implementing SAND messages to the DASH from at least one user device.

6. A method according to claim 4, wherein generating the resource allocation list between each user device and at least one channel with an associated representation index involves checking whether increasing the representation index associated with at least one user device means that the available airtime in a channel is greater than or equal to 0.

7. A method according to claim 6, wherein the available airtime using an increased representation index is greater than or equal to 0 and involves setting the available airtime in the channel to the available airtime using the increased representation index and setting the increased representation index as the representation index associated to the user device.

8. A method according to claim 6, wherein the channel is different from the channel associated with the user device, the available airtime in the channel associated with the user device is updated and the channel is set as the channel associated with the user device.

9. A method according to claim 6, wherein checking whether increasing the representation index associated with at least one user device means that the available airtime in a channel is greater than or equal to 0 is only performed if the representation index associated with the user device can be increased.

10. A method according to claim 6, wherein the user device is obtained from a list and each item on the list is a tuple with one element of the tuple being the airtime consumed by a user device associated with a channel using a representation index and another element of the tuple being the video rate of the user device using the representation index and the user device is obtained from at least one element of the tuple and the items on the list comprise all the possible combinations between user devices and channels.

11. A method according to claim 10, wherein the parameter of the representation index from any item on the list is initialized with the lowest representation index from the associated user device and the items on the list are sorted in ascending order using the airtime consumed by a user device associated with a channel using a representation index as a primary sorting key and the video rate associated with a representation index as a secondary sorting key.

12. A method according to claim 6, wherein checking whether increasing the representation index associated with at least one user device means that the available airtime in a channel is greater than or equal to 0 it is repeated as long as for at least one of the user devices the representation index is not the maximum representation index or there is any increase in the representation rate associated with at least one user device that allows that the available airtime in a channel is greater than or equal to 0.

13. A method according to claim 1, wherein the step of distributing the resource allocation list involves sending a list of at least one video rate associated with a user device to a server and the server sends a message to each user device on the list with the video rate associated.

14. A method according to claim 1, wherein the step of distributing the resource allocation list involves sending a list of at least one channel associated with a user device to a server and the server sends a message to each implicated access point to trigger the needed handovers.

15. A data processing device comprising means for carrying out the steps of claim 1.
